(19) United States
(12) Patent Application Publication
(10) Pub. No.: US 2025/0320128 A1
(43) Pub. Date: Oct. 16, 2025

(54) ZSM-5 MOLECULAR SIEVE, PREPARATION METHOD THEREFOR AND APPLICATION THEREOF, HYDROTREATMENT CATALYST, HYDRODEWAXING CATALYST, AND APPLICATIONS THEREOF

(71) Applicants: CHINA PETROLEUM & CHEMICAL CORPORATION, Beijing (CN); SINOPEC DALIAN RESEARCH INSTITUTE OF PETROLEUM AND PETROCHEMICALS CO., LTD., Dalian, Liaoning (CN)

(72) Inventors: Wenyue HAO, Dalian, Liaoning (CN); Chang LIU, Dalian, Liaoning (CN); Junhui GUO, Dalian, Liaoning (CN); Junfeng CAO, Dalian, Liaoning (CN); Fenglai WANG, Dalian, Liaoning (CN)

(21) Appl. No.: 18/705,687

(22) PCT Filed: Oct. 28, 2022
(86) PCT No.: PCT/CN2022/128201

§ 371 Date: Apr. 29, 2024

(30) Foreign Application Priority Data
Oct. 29, 2021 (CN) 202111269100.0

(51) Int. Cl. C01B 39/38; B01J 29/46

(52) U.S. Cl. CPC C01B 39/38; B01J 29/46; C01P 2002/72; C01P 2006/14

(57) ABSTRACT

A ZSM-5 molecular sieve, a preparation method therefor and an application thereof, a hydrotreatment catalyst, a hydrodewaxing catalyst, and applications thereof are provided. The ZSM-5 molecular sieve has a pyridine infrared total acid amount being 0.03-0.40 mmol/g, and a di-tert-butylpyridine infrared total acid amount being 0.002-0.02 mmol/g; and the mesoporous pore volume of the ZSM-5 molecular sieve accounts for 10-20% of the total pore volume, and/or in the ZSM-5 molecular sieve, the mesoporous pore volume of 2-10 nm accounts for 70-95% of the total mesoporous pore volume. The molecular sieve can be used as a carrier or an active component, for example, the hydrodewaxing catalyst prepared from the ZSM-5 molecular sieve is used for oil product treatment, such that the quality and the yield of a low-condensation-point oil product can be improved.

### CROSS-REFERENCE TO RELATED APPLICATIONS

The application claims the benefit of Chinese patent application No. “202111269100.0”, filed on Oct. 29, 2021, entitled “MODIFIED ZSM-5 MOLECULAR SIEVE AS WELL AS PREPARATION METHOD AND APPLICATION THEREOF”, the content of which is specifically and entirely incorporated herein by reference.

### TECHNICAL FIELD

The present invention relates to the technical field of molecular sieves and the preparation method thereof in particular to a ZSM-5 molecular sieve, a preparation method and an application thereof, a hydrotreatment catalyst, a hydrodewaxing catalyst, and applications thereof.

### BACKGROUND ART

The first molecular sieve belonging to the “Pentasil” family, named ZSM-5 molecular sieve, was successfully synthesized by the Mobile Corporation by using tetraethyl ammonium hydroxide as a template agent in 1972. The appearance of said molecular sieve marked a milestone for the development of the molecular sieves. In 1978, Kokotailo et al structurally analyzed the ZSM-5 molecular sieve and confirmed that the molecular sieve had a three-dimensional double ten-membered ring pore canal structure, which was composed of a straight pore canal and a sinusoidal pore canal, the two sets of ten-membered ring pore canals exhibited an orthogonal relationship, wherein the straight ten-membered ring pore canal was parallel to the b-axis and had a pore diameter of 0.53×0.56 nm, and the sinusoidal ten-membered ring pore canal was parallel to the a-axis and had a pore diameter of 0.51×0.55 nm, the crystal cell parameters were a=2.017 nm, b=1.996 nm, and c=1.343 nm, such a pore structure characteristic endowed the molecular sieve with the shape selective and catalytic properties. The hydrodewaxing reaction utilized the ten-membered ring pore canals of the molecular sieve, wherein the molecular dynamics sizes of most cyclic hydrocarbons and isomeric alkanes were larger than those of the ZSM-5 molecular sieve, thus the most cyclic hydrocarbons and isomeric alkanes cannot enter into the pore canals for carrying out reaction, thereby realizing the selective cracking of the chain hydrocarbons with poor low-temperature fluidity. The ZSM-5 molecular sieve raw powder suffered from side reactions due to the existence of pore openings and acidity on the outer surface, and the catalytic performance of the raw powder was influenced.

In order to obtain a catalyst with high para-position selectivity and reaction stability, the ZSM-5 molecular sieve must be modified. The silanization treatment of the molecular sieve is a frequently used and relatively effective method for modifying the acidity of an outer surface. The current silanization process can be classified into the following methods: (1) vacuum chemical vapor deposition method; (2) flow chemical vapor deposition method; (3) liquid phase chemical impregnation method; (4) reflux liquid phase deposition method; (5) chemical reaction deposition method, although the methods have different processes, each method aims to eliminate the outer surface acid center by loading amorphous silica on the outer surface of the molecular sieve through deposition. However, the traditional silanization method needs to be repeated many times, and circulates the impregnation process to fulfill the purpose of eliminating the outer surface acidity, which leads to the waste of a large amount of the silicon ester and the significantly reduced efficiency of the modification process; although the improved chemical reaction deposition method improves the modification efficiency and the utilization rate of silicon ester, the method needs special operations, which causes that the process is complicated, and inevitably brings about the problem of pore canal blockage.

### Contents of Invention

Aiming to overcome the defects in the prior art, the present application provides a ZSM-5 molecular sieve, a preparation method and an application thereof, a hydrotreatment catalyst, a hydrodewaxing catalyst, and applications thereof. The ZSM-5 molecular sieve can be widely used as a carrier or an active component, for example, the ZSM-5 molecular sieve can be used as the carrier for preparing a catalyst, which is utilized in the process of hydrodewaxing straight-run diesel oil blended with a portion of catalytic diesel oil and/or coking diesel oil, and can simultaneously improve the quality and yield of low freezing point diesel oil.

In the first aspect, the invention provides a ZSM-5 molecular sieve, wherein the ZSM-5 molecular sieve has a pyridine infrared total acid amount within the range of 0.03-0.40 mmol/g, and a di-tert-butylpyridine infrared total acid amount within the range of 0.002-0.02 mmol/g; and the mesoporous pore volume of the ZSM-5 molecular sieve accounts for 10-20% of the total pore volume, and/or in the ZSM-5 molecular sieve, the mesoporous pore volume of 2-10 nm accounts for 70-95% of the total mesoporous pore volume.

In the second aspect, the present invention provides a preparation method for the ZSM-5 molecular sieve according to the invention, the method comprises the following steps:
(1) subjecting a raw material ZSM-5 molecular sieve to a hydrothermal treatment;
(2) removing non-framework aluminum in the molecular sieve obtained in step (1);
(3) impregnating the material obtained in step (2) with a pore canal protection solution;
(4) treating the material obtained in step (3) with an organic acid;
(5) mixing the material obtained in step (4) with a dealuminizing and silicon supplementing reagent to dealuminize and supplement silicon;
(6) filtering, washing, drying, and roasting the material obtained in step (5).

In the third aspect, the invention provides a use of the molecular sieve as a carrier and/or a catalyst active component, preferably as a hydrogenation catalyst carrier.

In the fourth aspect, the invention provides a hydrotreatment catalyst comprising a ZSM-5 molecular sieve and a hydrogenation active component according to the invention.

In the fifth aspect, the invention provides a hydrodewaxing catalyst, the catalyst comprises the ZSM-5 molecular sieve according to the invention, preferably, the hydrodewaxing catalyst comprises the ZSM-5 molecular sieve and the group VIII metal component, wherein the ZSM-5 molecular sieve is contained in an amount of 30-90%, and the group VIII metal component is contained in an amount of 5-40% calculated in terms of oxide, based on the weight of said catalyst.

In the sixth aspect, the invention provides a use of the hydrodewaxing catalyst in the hydrodewaxing of oil products; preferably, the oil product is a mixture of straight-run diesel oil and catalytic diesel oil and/or coking diesel oil.

Compared with the prior art, the invention has the following advantages:

1. The ZSM-5 molecular sieve of the invention has a low di-tert-butylpyridine infrared total acid amount and exhibits a suitable mesoporous distribution while eliminating the mesoporous acid and external surface acid, the ZSM-5 molecular sieve can be widely used as a carrier or an active component, for example, the ZSM-5 molecular sieve can be used as the carrier for preparing a catalyst, which is utilized in the process of hydrodewaxing straight-run diesel oil blended with a portion of catalytic diesel oil and/or coking diesel oil, and can simultaneously improve the quality and yield of low freezing point diesel oil.

2. The preparation method of the ZSM-5 molecular sieve according to the invention has many advantages, firstly, a certain amount of mesopores are obtained through the hydrothermal treatment, the non-framework aluminum is then removed such that the pore canals are more unblocked, the acid centers in non-zigzag pore canals are selectively removed in a pore canal protection mode, a majority of aluminum sites in non-zigzag pore canals are replaced by the silicon atoms without acidity under the action of a dealuminizing and silicon supplementing reagent so that the molecular sieve structure is completely reserved.

In the preferred embodiment of the invention, a small number of acid centers on the outer surface and in mesopores of the molecular sieve can be reserved as required, so that the molecular sieve has better performance advantages, for example, when the molecular sieve is used in a hydrodewaxing catalyst, a small amount of polycyclic aromatic hydrocarbons in raw materials, which can be easily adsorbed, may be subjected to hydrogenation ring opening on weak acid sites in the mesopores and on the outer surface so that the diesel quality is improved, the monocyclic hydrocarbons and isomeric chain hydrocarbons which have a high mass amount and low condensation point are difficult to enter the microporous pore canals of ZSM-5 molecular sieve and are reserved in products due to poor competitive adsorption capacity. The adsorption capacity of the normal alkane is weaker than the aromatic hydrocarbon, and the normal alkane does not dominate in competitive adsorption outside the pore canal so the normal alkane enters the micropore canals to perform shape-selective cracking reaction to obtain a primary cracked product with a reduced condensation point, the reduced amount of outer surface acid center prevents the cracked product from being further cracked into smaller-molecular non-diesel components, the unblocked pore canal enables the primary cracked product to diffuse away from the pore canals in time, the secondary cracking is reduced, and finally the low condensation point diesel yield is greatly improved.

### DESCRIPTION OF FIGURES

FIG. 1 illustrates an X-ray diffraction (XRD) diagram of a commercially available ZSM-5 molecular sieve, a ZSM-5 molecular sieve Z-T4 obtained in Example 4 of the present invention, and a molecular sieve Z-B obtained in Comparative Example 1.

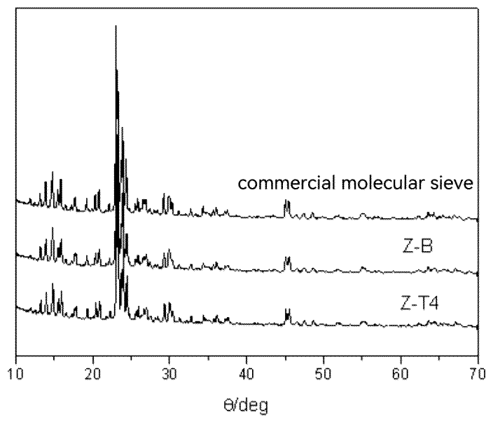

### SPECIFIC MODE FOR CARRYING OUT THE INVENTION

The functions and effects of the technical solution of the present invention will be further described below with reference to the Examples and Comparative Examples, but the following Examples are not intended to limit the protection scope of the invention.

The present invention provides a ZSM-5 molecular sieve, wherein the ZSM-5 molecular sieve has a pyridine infrared total acid amount within the range of 0.03-0.40 mmol/g (e.g., 0.03 mmol/g, 0.04 mmol/g, 0.05 mmol/g, 0.06 mmol/g, 0.07 mmol/g, 0.08 mmol/g, 0.09 mmol/g, 0.10 mmol/g, 0.11 mmol/g, 0.12 mmol/g, 0.13 mmol/g, 0.14 mmol/g, 0.15 mmol/g, 0.16 mmol/g, 0.17 mmol/g, 0.18 mmol/g, 0.19 mmol/g, 0.20 mmol/g, 0.21 mmol/g, 0.22 mmol/g, 0.23 mmol/g, 0.24 mmol/g, 0.25 mmol/g, 0.26 mmol/g, 0.27 mmol/g, 0.28 mmol/g, 0.29 mmol/g, 0.30 mmol/g, 0.31 mmol/g, 0.32 mmol/g, 0.33 mmol/g, 0.34 mmol/g, 0.35 mmol/g, 0.36 mmol/g, 0.37 mmol/g, 0.38 mmol/g, 0.39 mmol/g, 0.40 mmol/g), and a di-tert-butylpyridine infrared total acid amount within the range of 0.002-0.02 mmol/g (e.g., 0.002 mmol/g, 0.003 mmol/g, 0.004 mmol/g, 0.005 mmol/g, 0.006 mmol/g, 0.007 mmol/g, 0.008 mmol/g, 0.009 mmol/g, 0.010 mmol/g, 0.011 mmol/g, 0.012 mmol/g, 0.013 mmol/g, 0.014 mmol/g, 0.015 mmol/g, 0.016 mmol/g, 0.017 mmol/g, 0.018 mmol/g, 0.019/g, 0.020 mmol/g); the mesoporous pore volume of the ZSM-5 molecular sieve accounts for 10-20% of the total pore volume, for example, 10%, 11%, 12%, 13%, 14%, 15%, 16%, 17%, 18%, 19%, 20%; and/or in the ZSM-5 molecular sieve, the mesoporous pore volume of 2-10 nm accounts for 70-95% of the total mesoporous pore volume, such as 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%.

According to a preferred embodiment of the invention, the ZSM-5 molecular sieve has a pyridine infrared total acid amount within the range of 0.10-0.20 mmol/g (e.g., 0.10 mmol/g, 0.11 mmol/g, 0.12 mmol/g, 0.13 mmol/g, 0.14 mmol/g, 0.15 mmol/g, 0.16 mmol/g, 0.17 mmol/g, 0.18 mmol/g, 0.19 mmol/g, 0.20 mmol/g); and a di-tert-butylpyridine infrared total acid amount within the range of 0.005-0.01 mmol/g (e.g., 0.005 mmol/g, 0.006 mmol/g, 0.007 mmol/g, 0.008 mmol/g, 0.009 mmol/g, 0.010 mmol/g).

According to a preferred embodiment of the invention, the ratio of the outer surface SiO₂/Al₂O₃ molar ratio of said ZSM-5 molecular sieve to the total SiO₂/Al₂O₃ molar ratio of said ZSM-5 molecular sieve is within the range of (2-100):1, preferably within the range of (5-30):1, for example, 5:1, 6:1, 7:1, 8:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, 30:1.

According to a preferred embodiment of the invention, the outer surface SiO₂/Al₂O₃ molar ratio of said ZSM-5 molecular sieve is within the range of 200-1,000, preferably within the range of 500-1,000.

According to a preferred embodiment of the invention, the total SiO₂/Al₂O₃ molar ratio of said ZSM-5 molecular sieve is within the range of 30-100, preferably within the range of 40-70.

According to a preferred embodiment of the invention, the mesoporous pore volume of the ZSM-5 molecular sieve accounts for 10-20% of the total pore volume.

According to a preferred embodiment of the invention, in the ZSM-5 molecular sieve, the mesoporous pore volume of 2-10 nm accounts for 70-95% of the total mesoporous pore volume.

Each of the molecular sieves having the foregoing properties of the invention can achieve the objects of the present invention, the invention does not impose particular requirements on the preparation method thereof; according to a preferred embodiment of the present invention, the invention provides a preparation method of the ZSM-5 molecular sieve, the method comprises the following steps:
(1) subjecting a raw material ZSM-5 molecular sieve to a hydrothermal treatment;
(2) removing non-framework aluminum in the molecular sieve obtained in step (1);
(3) impregnating the material obtained in step (2) with a pore canal protection solution;
(4) treating the material obtained in step (3) with an organic acid;
(5) mixing the material obtained in step (4) with a dealuminizing and silicon supplementing reagent to dealuminize and supplement silicon;
(6) filtering, washing, drying, and roasting the material obtained in step (5).

In the invention, the ZSM-5 molecular sieve raw material may be a commercially available product or a microporous hydrogen type ZSM-5 molecular sieve prepared according to the prior art. Preferably, the ZSM-5 molecular sieve raw material has the following properties: the SiO₂/Al₂O₃ molar ratio is within the range of 30-100, the specific surface area is within the range of 300-450 m²/g, and the pore volume is within the range of 0.15-0.20 cm³/g.

According to a preferred embodiment of the present invention, in step (1), the temperature of the hydrothermal treatment is within the range of 400-700° C., preferably within the range of 500-600° C.

According to the present invention, the time of the hydrothermal treatment is adjusted depending on the temperature, and in the present invention, the time of the hydrothermal treatment is preferably within the range of 0.5-5 h, more preferably within the range of 1-2 h.

According to the present invention, the pressure of the hydrothermal treatment is adjusted depending on the temperature, and in the present invention, the pressure of the hydrothermal treatment is within the range of 0.05-0.5 MPa, preferably within the range of 0.1-0.3 MPa.

In the present invention, the methods for removing non-framework aluminum may be various, including but not limited to removing non-framework aluminum with a buffer solution, wherein the buffer solution is a mixed solution of the weak acid and/or weak base and corresponding salt thereof, the mixed solution can counteract and alleviate the influence of the added strong acid or strong base on the pH value of the solution to a certain extent, thereby keeping relative stability of the pH value of the solution.

Unless otherwise specified in the present invention, the solution refers to an aqueous solution.

In the present invention, the weak acid is preferably an inorganic acid and/or an organic acid that has a molecular size of less than 0.5 nm and can be removed in a mode of not damaging the structure of molecular sieve.

According to a preferred embodiment of the present invention, the inorganic acid is one or more of phosphoric acid, carbonic acid, and boric acid.

According to a preferred embodiment of the present invention, the inorganic acid salt is one or more of ammonium phosphate salt, ammonium carbonate salt, and ammonium borate salt.

According to a preferred embodiment of the present invention, the organic acid is selected from C2-C6 monobasic acid or polybasic acid, preferably one or more selected from the group consisting of citric acid, formic acid, acetic acid, oxalic acid, propionic acid, malonic acid, butyric acid, and succinic acid.

According to a preferred embodiment of the invention, the organic acid salt is selected from C2-C6 monoacid or polybasic acid salts, preferably one or more selected from the group consisting of ammonium citrate, ammonium formate, ammonium acetate, ammonium oxalate, ammonium propionate, ammonium malonate, ammonium butyrate, and ammonium succinate.

According to a preferred embodiment of the present invention, more preferably, the buffer solution is one or more of oxalic acid-ammonium oxalate solution and acetic acid-ammonium acetate solution.

According to a preferred embodiment of the present invention, the buffer solution is acidic, and the pH value of the buffer solution is preferably within the range of 4.5-6.5.

According to a preferred embodiment of the present invention, the molar concentration of the organic acid in the buffer solution is within the range of 0.1-1.0 mol/L.

The dosage of the buffer solution in the invention may be selected from a wide range. According to a preferred embodiment of the invention, the liquid-solid volume ratio of the buffer solution to the molecular sieve obtained in step (1) is within the range of 3:1-10:1.

According to a preferred embodiment of the invention, the process of step (2) comprises: mixing and stirring the molecular sieve obtained in step (1) and a buffer solution, and then carrying out a solid-liquid separation; optionally repeating the above operations for 2-4 times; according to the invention, preferably, the treatment temperature is within the range of 40-80° C., and the treatment time is adjusted depending on the temperature, the treatment time is preferably within the range of 0.5-3 h.

In the present invention, the pore canal protecting agent of the pore canal protection solution is an inorganic alkali and/or an organic alkali that has a molecular size of less than 0.5 nm and can be removed through roasting in a mode of not damaging the structure of molecular sieve, such as one or more selected from the group consisting of aqua ammonia, ethylenediamine, propylamine, tetramethylammonium hydroxide, tetraethylammonium hydroxide, tetrapropylammonium hydroxide, tetramethylammonium bromide and tetraethylammonium bromide.

According to a preferred embodiment of the present invention, in step (3), the pore canal protecting agent of the pore canal protection solution is one or more selected from the group consisting of isopropylamine, tetramethylammonium hydroxide, tetraethylammonium hydroxide, and tetrapropylammonium hydroxide.

According to a preferred embodiment of the present invention, preferably, the pore canal protection solution is an aqueous solution of a pore canal protection agent, preferably one or more selected from the group consisting of isopropylamine solution, tetraethylammonium hydroxide solution, and tetrapropylammonium hydroxide solution.

According to a preferred embodiment of the invention, preferably, the concentration of the pore canal protection solution is within the range of 0.8-2.0 mol/L.

The present invention does not impose specific requirements on the impregnation method, and in the present invention, the impregnation is an equivalent-volume impregnation.

According to a preferred embodiment of the invention, the impregnation treatment temperature is within the range of 20-25° C.

In the present invention, the organic acid in step (4) is an organic acid that has a molecular size within the range from 0.55 nm to 2 nm and can be removed through roasting in a mode of not damaging the structure of molecular sieve. For example, one or more selected from the group consisting of the C7-C10 organic acids.

According to a preferred embodiment of the invention, the organic acid is one or more selected from the group consisting of 2-methylbenzoic acid, 2-methylbenzenesulfonic acid, 2,4-dimethylbenzenesulfonic acid, 2,4-dimethylbenzoic acid, 1,2,5-trimethylbenzenesulfonic acid, and 1,2,5-trimethylbenzoic acid.

According to a preferred embodiment of the present invention, it is further preferred that the organic acid in step (4) is one or more of 2,4-dimethylbenzenesulfonic acid and 2,4-dimethylbenzoic acid.

According to a preferred embodiment of the invention, the treatment process of step (4) comprises the following steps: mixing the material obtained in step (3) with water, preferably, the liquid-solid volume ratio of the water to the material obtained in step (3) is within the range of 2:1-6:1; and then adding an organic acid until the pH value of said solution is reduced to below 8, preferably within the range of 6.5-7.5.

In the present invention, the selectable range of the kinds of the dealuminizing and silicon supplementing reagent in step (5) is wide, and according to a preferred embodiment of the invention, the dealuminizing and silicon supplementing substance of the dealuminizing and silicon supplementing reagent is one or more selected from the group consisting of fluosilicic acid, fluosilicate (including but not limited to ammonium hexafluorosilicate, fluosilicic acid, sodium fluorosilicate), silicon halide (including but not limited to silicon tetrachloride, silicon tetrafluoride) and silicate ester (including but not limited to ethyl orthosilicate), preferably one or more selected from the group consisting of ammonium hexafluorosilicate, fluosilicic acid, sodium fluosilicate, silicon tetrachloride, silicon tetrafluoride and ethyl orthosilicate; more preferably, the dealuminizing and silicon supplementing reagent is at least one of ammonium hexafluorosilicate solution and tetraethoxysilane solution.

According to a preferred embodiment of the invention, the molar concentration of the dealuminizing and silicon supplementing reagent is within the range of 0.3-1.0 mol/L

According to the invention, the dosage of the dealuminizing and silicon supplementing reagent can be selected from a wide range, and according to a preferred embodiment of the invention, the quality ratio of the material obtained in step (4) to the dealuminizing and silicon supplementing reagent is within the range of 1:1-1:5.

According to a preferred embodiment of the present invention, in step (5), the mixing temperature is within the range of 60-100° C.

According to a preferred embodiment of the present invention, the operation procedure of step (5) comprises the following steps: heating the material obtained in step (4) to the temperature range of 60-100° C., continuously stirring, dropwise adding a dealuminizing and silicon supplementing reagent, and continuously stirring for 60-120 min after completion of the dropwise adding process.

According to a preferred embodiment of the present invention, the filtering and washing in step (6) are preferably performed by using a conventional method in the art, the drying temperature is within the range of 100-150° C., the drying time is within the range of 2-4 hours; the roasting temperature is within the range of 400-600° C.; the roasting time is within the range of 3-5 h.

The invention provides a use of the molecular sieve as a carrier and/or a catalyst active component, preferably as a hydrogenation catalyst carrier.

The present invention provides a hydrotreatment catalyst, the hydrotreatment catalyst comprising a ZSM-5 molecular sieve and a hydrogenation active component according to the invention; preferably, the hydrogenation active component is one or more selected from the group consisting of the group VIB metals, the group VIIB metals, and the group VIII metals, preferably one or more selected from the group consisting of Pt, Pd, Ni, W, Mo, and Co.

The present invention provides a hydrodewaxing catalyst comprising the ZSM-5 molecular sieve according to the invention.

According to a preferred embodiment of the present invention, preferably, the hydrodewaxing catalyst comprises the ZSM-5 molecular sieve and the Group VIII metal component, wherein the ZSM-5 molecular sieve is contained in an amount of 30-90%, and the Group VIII metal component is contained in an amount of 5-40% calculated in terms of oxide, based on the weight of said catalyst.

The present invention provides a use of the hydrodewaxing catalyst according to the invention in the hydrodewaxing of oil products; preferably, the oil product is a mixture of straight-run diesel oil and catalytic diesel oil and/or coking diesel oil.

According to a preferred embodiment of the invention, the outer surface SiO₂/Al₂O₃ molar ratio of said ZSM-5 molecular sieve is within the range of 200-1,000, the total SiO₂/Al₂O₃ molar ratio of said ZSM-5 molecular sieve is within the range of 30-100, the ZSM-5 molecular sieve has a pyridine infrared total acid amount within the range of 0.03-0.40 mmol/g, and a di-tert-butylpyridine infrared total acid amount within the range of 0.002-0.02 mmol/g; and the mesoporous pore volume of the ZSM-5 molecular sieve accounts for 10-20% of the total pore volume.

According to a preferred embodiment of the invention, preferably, the ZSM-5 molecular sieve has an outer surface SiO₂/Al₂O₃ molar ratio within the range of 500-1,000, and the total SiO₂/Al₂O₃ molar ratio within the range of 40-70.

According to a preferred embodiment of the present invention, preferably, the ZSM-5 molecular sieve has a pyridine infrared total acid amount within the range of 0.10-0.20 mmol/g, and a di-tert-butylpyridine infrared total acid amount within the range of 0.005-0.01 mmol/g.

According to a preferred embodiment of the present invention, preferably, the mesopores in the ZSM-5 molecular sieve are concentrated in the pore diameter of 2-10 nm, wherein the mesoporous pore volume of 2-10 nm accounts for 70-95% of the total mesoporous pore volume. In the present invention, the mesoporous pores refer to the pores having a pore diameter of 2-50 nm.

According to a preferred embodiment of the present invention, the invention provides a preparation method for the ZSM-5 molecular sieve, the method comprises the following steps: (1) subjecting a raw material ZSM-5 molecular sieve to a hydrothermal treatment;
(2) removing non-framework aluminum in the molecular sieve obtained in step (1);
(3) impregnating the material obtained in step (2) with a pore canal protection solution;
(4) treating the material obtained in step (3) with an organic acid;
(5) mixing the material obtained in step (4) with a dealuminizing and silicon supplementing reagent to dealuminize and supplement silicon;
(6) filtering, washing, drying, and roasting the material obtained in step (5).

According to a preferred embodiment of the present invention, it is preferable in step (1), the temperature of the hydrothermal treatment is within the range of 400-700° C., more preferably within the range of 500-600° C.; the time of the hydrothermal treatment is within the range of 0.5-5 h, more preferably within the range of 1-2 h; the pressure of the hydrothermal treatment is within the range of 0.05-0.5 MPa, more preferably within the range of 0.1-0.3 MPa.

According to a preferred embodiment of the present invention, preferably in step (2), the method of removing non-framework aluminum may be the method of removing non-framework aluminum with a buffer solution. The buffer solution in use is one or more of oxalic acid-ammonium oxalate solution and acetic acid-ammonium acetate solution. The pH value of the buffer solution is within the range of 4.5-6.5, preferably within the range of 5.0-6.0. The molar concentration of the organic acid in the buffer solution is within the range of 0.1-1.0 mol/L. The liquid-solid volume ratio of the buffer solution to the molecular sieve obtained in step (1) is within the range of 3:1-10:1.

According to a preferred embodiment of the present invention, the specific treatment process in step (2) preferably comprises: mixing and stirring the molecular sieve obtained in step (1) and a buffer solution, wherein the treatment temperature is within the range of 40-80° C., and the treatment time is within the range of 0.5-3 h, the mixture is then subjected to a solid-liquid separation (e.g., a suction filtration); and the above operations are repeated for 2-4 times.

According to a preferred embodiment of the present invention, the pore canal protection solution in step (3) is preferably one or more selected from the group consisting of isopropylamine solution, tetraethylammonium hydroxide solution, and tetrapropylammonium hydroxide solution. The concentration of the pore canal protection solution is within the range of 0.8-2.0 mol/L, preferably within the range of 1.1-1.5 mol/L.

According to a preferred embodiment of the present invention, the impregnation in step (3) is preferably an equivalent-volume impregnation. The impregnation treatment temperature is the normal atmospheric temperature, generally within the range of 20-25° C.

According to a preferred embodiment of the present invention, the organic acid in step (4) is preferably one or more of 2,4-dimethylbenzenesulfonic acid and 2,5-dimethylbenzoic acid.

According to a preferred embodiment of the present invention, the specific operations are preferably as follows: initially mixing the material obtained in step (3) with water, wherein the liquid-solid volume ratio of the water to the material obtained in step (3) is within the range of 2:1-6:1; and then adding an organic acid until the pH value of said solution is reduced to below 8, preferably within the range of 6.5-7.5.

According to a preferred embodiment of the present invention, the dealuminizing and silicon supplementing reagent in step (5) is preferably at least one of ammonium hexafluorosilicate solution and tetraethoxysilane solution. The molar concentration of the dealuminizing and silicon supplementing reagent is within the range of 0.3-1.0 mol/L. The quality ratio of the material obtained in step (4) to the dealuminizing and silicon supplementing reagent is within the range of 1: 1-1:5. The mixing temperature is within the range of 60-100° C.

According to a preferred embodiment of the present invention, the specific operation procedure of step (5) preferably comprises the following steps: rapidly heating the material obtained in step (4) to the temperature range of 60-100° C., continuously stirring, dropwise adding a dealuminizing and silicon supplementing reagent, and continuously stirring for 60-120 min after completion of the dropwise adding process. Wherein the dropwise adding rate is not more than 0.5 mL/min g of the material obtained in step (4); preferably within the range of 0.2-0.4 mL/min g of the material obtained in step (4).

According to a preferred embodiment of the present invention, the filtering and washing in step (6) are preferably performed by using a conventional method in the art, the drying temperature is within the range of 100-150° C., the drying time is within the range of 2-4 hours; the roasting temperature is within the range of 400-600° C.; the roasting time is within the range of 3-5 h.

According to a preferred embodiment of the present invention, the invention provides a hydrodewaxing catalyst comprising the aforementioned ZSM-5 molecular sieve.

According to a preferred embodiment of the present invention, preferably, the hydrodewaxing catalyst comprises the ZSM-5 molecular sieve and the group VIII metal component, wherein the ZSM-5 molecular sieve is contained in an amount of 30-90%, more preferably 40-70%, and the group VIII metal component is contained in an amount of 5-40%, more preferably 10-30% calculated in terms of oxide, based on the weight of said catalyst.

According to a preferred embodiment of the present invention, preferably, the hydrodewaxing catalyst comprises the ZSM-5 molecular sieve, alumina and group VIII metal components, wherein the ZSM-5 molecular sieve is contained in an amount of 30-50%, the alumina is contained in an amount of 40-70%, and the group VIII metal component is contained in an amount of 5-40% calculated in terms of oxide, based on the weight of said catalyst.

According to a preferred embodiment of the present invention, the group VIII metal is preferably cobalt and/or nickel.

According to a preferred embodiment of the invention, the invention provides a use of the hydrodewaxing catalyst in the hydrodewaxing of the raw oil.

According to a preferred embodiment of the present invention, the use preferably comprises: in the presence of hydrogen gas, the raw oil is subjected to the reaction under the action of the hydrodewaxing catalyst to obtain the low-freezing point diesel.

According to a preferred embodiment of the present invention, preferably, the reaction conditions for hydrodewaxing in the use are as follows: the reaction pressure is within the range of 5.0-8.0 MPa, the volume ratio of hydrogen to oil is within the range of 400:1-600:1, the liquid hourly volume space velocity is within the range of 0.5-2 h-1, and the reaction temperature is within the range of 280-400° C.

According to a preferred embodiment of the present invention, the raw oil is preferably a mixture of straight-run diesel oil, catalytic diesel oil, and/or coking diesel oil. In the raw oil, the total blending amount of the catalytic diesel oil and/or coking diesel oil is within the range of 20-40%, the quality content of wax (normal alkane with carbon atom number more than 20) is within the range of 5-15%, and the quality content of polycyclic aromatic hydrocarbons is within the range of 10-30%. The distillation range of the raw oil is generally within the range of 150-400° C.

Unless otherwise specified in the present invention, the % involved in Examples and Comparative Examples refers to the mass fraction.

In the invention, the outer surface SiO₂/Al₂O₃ molar ratio was measured by the X-ray photoelectron spectroscopy (XPS), the composition and the state of elements on the catalyst surface were measured by using the Multilab2000 type electron spectrometer manufactured by the ThermoFisher Corporation in the United States of America (USA), an excitation source was Mg Ka, the cathode voltage and current were 13 kV and 20 mA respectively. The electron binding energy was calibrated with C1s (284.6 eV).

In the invention, the total SiO₂/Al₂O₃ molar ratio was obtained by analyzing the X-ray fluorescence (XRF) spectrum, the ZSX100e X-ray fluorescence spectrometer was adopted, the spectral line was Ka, the crystal was Li F1, the target material was Rh, the detector was SC scintillation, the timing was 20 s, and the light path atmosphere was vacuum.

In the invention, the specific surface area, the pore volume, and the pore distribution were determined by the following measuring methods: the ASAP 2420 low-temperature liquid nitrogen physical adsorption instrument manufactured by the MICROMERITICS in the United States of America (USA) was adopted, and the pretreatment temperature was 300° C., and the pretreatment time was 4 h.

In the invention, the measuring method of the pyridine infrared total acid amount was as follows: the powdered ZSM-5 molecular sieve was compressed into tablets, which were subjected to vacuumizing, and then degassing at 450° C. for 2 h. When the temperature was reduced to room temperature, pyridine molecules were used as probe molecules, an infrared spectrogram of chemical desorption was measured, and the adsorption quantity was calculated.

In the invention, the di-tert-butylpyridine infrared total acid amount was referred to as the protonic acid which can be contacted by the 2,6-di-tert-butylpyridine molecule with a kinetics diameter of 10.5 Å. The measurement method of the di-tert-butylpyridine infrared total acid amount was as follows: the powdered ZSM-5 molecular sieve was compressed into tablets, which were subjected to vacuumizing, and then degassing at 450° C. for 2 h. When the temperature was reduced to room temperature, the 2,6-di-tert-butyl pyridine molecules were used as probe molecules, an infrared spectrogram of chemical desorption was measured, and the adsorption quantity was calculated.

The ZSM-5 raw powder involved in the Examples and the Comparative Examples was a commercially available commodity, it was a microporous hydrogen type ZSM-5 molecular sieve, and the properties of the ZSM-5 molecular sieve were as follows: the specific surface area was 405 m²/g, the pore volume was 0.182 cm³/g, the water absorption rate was 55%, and the SiO₂/Al₂O₃ (molar) ratio was 31.2.

### EXAMPLE 1

30 g of the commercially available ZSM-5 raw powder was placed in a hydrothermal treatment furnace, and subjected to the treatment at 500° C. and under the pressure of 0.1 MPa for 2 h, the obtained material was placed in 300 mL of oxalic acid-ammonium oxalate solution with the pH value of 6.0, wherein the molar concentration of oxalic acid was 0.3 mol/L, the mixture was stirred and heated to 60° C., the mixture was subjected to suction filtration for 30 min, and the process was repeated for 3 times. 16.5 mL of isopropylamine solution with a concentration of 1.1 mol/L was then used for performing an equivalent-volume impregnation, and standing still for 10 min; 170 mL of water was added, 2,5-xylene sulfonic acid was dropwise added until the pH value was 6.5, the mixture was stirred and heated to 60° C., 90 mL of ammonium hexafluorosilicate solution with a concentration of 0.3 mol/L was dropwise added at a constant speed by a peristaltic pump, the dropwise adding rate was 0.2 mL/min g, and the temperature was kept at 60° C. and the stirring was continued for 90 min. The suction filtration was performed while the solution was hot, 300 mL of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T1 was prepared.

### Example 2

30 g of the commercially available ZSM-5 raw powder was placed in a hydrothermal treatment furnace, and subjected to the treatment at 530° C. and under the pressure of 0.1 MPa for 2 h, the obtained material was placed in 300 mL of acetic acid-ammonium acetate solution with the pH value of 6.0, wherein the molar concentration of acetic acid was 0.2 mol/L, the mixture was stirred and heated to 60° C., the mixture was subjected to suction filtration for 30 min, and the process was repeated for 3 times. 16.5 mL of tetraethylammonium hydroxide solution with a concentration of 1.2 mol/L was then used for performing an equivalent-volume impregnation, and standing still for 10 min; 170 mL of water was added, 2,5-dimethylbenzoic acid was dropwise added until the pH value was 7.0, the mixture was stirred and heated to 65° C., 90 mL of ammonium hexafluorosilicate solution with a concentration of 0.5 mol/L was dropwise added at a constant speed by a peristaltic pump, the dropwise adding rate was 0.2 mL/min g, and the temperature was kept at 65° C. and the stirring was continued for 90 min. The suction filtration was performed while the solution was hot, 300 mL of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T2 was prepared.

### Example 3

30 g of the commercially available ZSM-5 raw powder was placed in a hydrothermal treatment furnace, and subjected to the treatment at 550° C. and under the pressure of 0.1 MPa for 2 h, the obtained material was placed in 300 mL of oxalic acid-ammonium oxalate solution with the pH value of 5.5, wherein the molar concentration of oxalic acid was 0.4 mol/L, the mixture was stirred and heated to 70° C., the mixture was subjected to suction filtration for 30 min, and the process was repeated for 3 times. 16.5 mL of tetrapropylammonium hydroxide solution with a concentration of 1.2 mol/L was then used for performing an equivalent-volume impregnation on the obtained material, and standing still for 10 min; 170 mL of water was added, 2,4-dimethylbenzenesulfonic acid was dropwise added until the pH value was 6.5, the mixture was stirred and heated to 65° C., 90 mL of tetraethoxysilane solution with a concentration of 0.6 mol/L was dropwise added at a constant speed by a peristaltic pump, the dropwise adding rate was 0.3 mL/min g, and the temperature was kept at 65° C. and the stirring was continued for 90 min. The suction filtration was performed while the solution was hot, 300 ml of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T3 was prepared.

### Example 4

30 g of the commercially available ZSM-5 raw powder was placed in a hydrothermal treatment furnace, and subjected to the treatment at 550° C. and under the pressure of 0.15 MPa for 2 h, the obtained material was placed in 300 mL of oxalic acid-ammonium oxalate solution with the pH value of 5.5, wherein the molar concentration of oxalic acid was 0.4 mol/L, the mixture was stirred and heated to 80° C., the mixture was subjected to suction filtration for 30 min, and the process was repeated for 3 times. 16.5 mL of isopropylamine solution with a concentration of 1.2 mol/L was then used for performing an equivalent-volume impregnation on the obtained material, and standing still for 10 min; 170 mL of water was added, 2,4-xylene sulfonic acid was dropwise added until the pH value was 7.0, the mixture was stirred and heated to 65° C., 90 g of ammonium hexafluorosilicate solution with a concentration of 0.6 mol/L was dropwise added at a constant speed by a peristaltic pump, the dropwise adding rate was 0.3 mL/min g, and the temperature was kept at 65° C. and the stirring was continued for 90 min. The suction filtration was performed while the solution was hot, 300 ml of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T4 was prepared.

### Example 5

30 g of the commercially available ZSM-5 raw powder was placed in a hydrothermal treatment furnace, and subjected to the treatment at 550° C. and under the pressure of 0.15 MPa for 2 h, the obtained material was placed in 300 mL of oxalic acid-ammonium oxalate solution with the pH value of 5.0, wherein the molar concentration of oxalic acid was 0.3 mol/L, the mixture was stirred and heated to 60° C., the mixture was subjected to suction filtration for 30 min, and the process was repeated for 3 times. 16.5 mL of isopropylamine solution with a concentration of 1.2 mol/L was then used for performing an equivalent-volume impregnation, and standing still for 10 min; 170 mL of water was added, 2,4-dimethylbenzoic acid was dropwise added until the pH value was 7.0, the mixture was stirred and heated to 65° C., 90 mL of ammonium hexafluorosilicate solution with a concentration of 0.6 mol/L was dropwise added at a constant speed by a peristaltic pump, the dropwise adding rate was 0.3 mL/min g, and the temperature was kept at 65° C. and the stirring was continued for 90 min. The suction filtration was performed while the solution was hot, 300 mL of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T5 was prepared.

### Example 6

30 g of the commercially available ZSM-5 raw powder was placed in a hydrothermal treatment furnace, and subjected to the treatment at 550° C. and under the pressure of 0.15 MPa for 2 h, the obtained material was placed in 300 mL of acetic acid-ammonium acetate solution with the pH value of 5.0, wherein the molar concentration of acetic acid was 0.3 mol/L, the mixture was stirred and heated to 60° C., the mixture was subjected to suction filtration for 30 min, and the process was repeated for 3 times. 16.5 mL of tetraethylammonium hydroxide solution with a concentration of 1.3 mol/L was then used for performing an equivalent-volume impregnation on the obtained material, and standing still for 10 min; 170 mL of water was added, 2,4-dimethylbenzenesulfonic acid was dropwise added until the pH value was 7.5, the mixture was stirred and heated to 65° C., 90 mL of ammonium hexafluorosilicate solution with a concentration of 0.6 mol/L was dropwise added at a constant speed by a peristaltic pump, the dropwise adding rate was 0.3 mL/min g, and the temperature was kept at 65° C. and the stirring was continued for 90 min. The suction filtration was performed while the solution was hot, 300 ml of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T6 was prepared.

### Example 7

30 g of the commercially available ZSM-5 raw powder was placed in a hydrothermal treatment furnace, and subjected to the treatment at 570° C. and under the pressure of 0.15 MPa for 2 h, the obtained material was placed in 300 mL of acetic acid-ammonium acetate solution with the pH value of 5.0, wherein the molar concentration of acetic acid was 0.5 mol/L, the mixture was stirred and heated to 60° C., the mixture was subjected to suction filtration for 30 min, and the process was repeated for 3 times. 16.5 mL of isopropylamine solution with a concentration of 1.5 mol/L was then used for performing an equivalent-volume impregnation on the obtained material, and standing still for 10 min; 170 mL of water was added, 2,4-dimethylbenzoic acid was dropwise added until the pH value was 7.5, the mixture was stirred and heated to 65° C., 90 mL of ethyl orthosilicate solution with a concentration of 0.8 mol/L was dropwise added at a constant speed by a peristaltic pump, the dropwise adding rate was 0.4 mL/min g, and the temperature was kept at 65° C. and the stirring was continued for 90 min. The suction filtration was performed while the solution was hot, 300 mL of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T7 was prepared.

### Example 8

30 g of the commercially available ZSM-5 raw powder was placed in a hydrothermal treatment furnace, and subjected to the treatment at 570° C. and under the pressure of 0.2 MPa for 2 h, the obtained material was placed in 300 mL of oxalic acid-ammonium oxalate solution with the pH value of 5.0, wherein the molar concentration of oxalic acid was 0.5 mol/L, the mixture was stirred and heated to 60° C., the mixture was subjected to suction filtration for 30 min, and the process was repeated for 3 times. 16.5 mL of isopropylamine solution with a concentration of 1.5 mol/L was then used for performing an equivalent-volume impregnation on the obtained material, and standing still for 10 min; 170 mL of water was added, 2,4-dimethylbenzoic acid was dropwise added until the pH value was 7.5, the mixture was stirred and heated to 65° C., 90 mL of ammonium hexafluorosilicate solution with a concentration of 1.0 mol/L was dropwise added at a constant speed by a peristaltic pump, the dropwise adding rate was 0.4 mL/min g, and the temperature was kept at 65° C. and the stirring was continued for 90 min. The suction filtration was performed while the solution was hot, 300 mL of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-T8 was prepared.

### Comparative Example 1

30 g of the commercially available ZSM-5 raw powder was placed in a hydrothermal treatment furnace, and subjected to the treatment at 550° C. and under the pressure of 0.15 MPa for 2 h, the obtained material was placed in 300 mL of oxalic acid-ammonium oxalate solution with the pH value of 5.0, wherein the molar concentration of oxalic acid was 0.3 mol/L, the mixture was stirred and heated to 60° C., the mixture was subjected to suction filtration for 30 min, and the process was repeated for 3 times. The filter cake was dried at 120° C. for 24 h and then roasted at 500° C. for 3 h, the molecular sieve denoted as Z-B was prepared.

### Comparative Example 2

30 g of the commercially available ZSM-5 raw powder was placed in a hydrothermal treatment furnace, and subjected to the treatment at 550° C. and under the pressure of 0.15 MPa for 2 h, the obtained material was placed in 300 mL of oxalic acid-ammonium oxalate solution with the pH value of 5.0, wherein the molar concentration of oxalic acid was 0.3 mol/L, the mixture was stirred and heated to 60° C., the mixture was subjected to suction filtration for 30 min, and the process was repeated for 3 times. 90 mL of ammonium hexafluorosilicate solution with a concentration of 0.6 mol/L was dropwise added into the obtained material at a constant speed by a peristaltic pump, the dropwise adding rate was 0.3 mL/min g, and the temperature was kept at 65° C. and the stirring was continued for 90 min. The suction filtration was performed while the solution was hot, the filter cake was dried at 120° C. for 24 h and then roasted at 500° C. for 3 h, and the molecular sieve denoted as Z-C was prepared.

### Comparative Example 3

30 g of the commercially available ZSM-5 raw powder was placed in a hydrothermal treatment furnace, and subjected to the treatment at 550° C. and under the pressure of 0.15 MPa for 2 h, 16.5 mL of isopropylamine solution with the concentration of 0.6 mol/L was used for performing an equivalent-volume impregnation on the obtained material, and standing still for 10 min; 170 mL of water was added, 2,4-dimethylbenzoic acid was dropwise added until the pH value was 7.0, the mixture was stirred and heated to 65° C., 90 mL of ammonium hexafluorosilicate solution with a concentration of 0.6 mol/L was dropwise added at a constant speed by a peristaltic pump, the dropwise adding rate was 0.3 mL/min g, and the temperature was kept at 65° C. and the stirring was continued for 90 min. The suction filtration was performed while the solution was hot, 300 ml of water was added into the obtained filter cake, then heated to 60° C. and the temperature was preserved for 20 min, the suction filtration was performed while the filter cake was hot, the filter cake was dried at 120° C. for 24 h, and then roasted at 500° C. for 3 h, the molecular sieve denoted as Z-D was prepared.

### Comparative Example 4

30 g of the commercially available ZSM-5 raw powder was stirred and heated to 65° C., 180 mL of ammonium hexafluorosilicate solution with a concentration of 1.0 mol/L was dropwise added at a constant speed by a peristaltic pump, the dropwise adding rate was 0.4 mL/min·g, and the temperature was kept at 65° C. and the stirring was continued for 90 min. The suction filtration was performed while the solution was hot, the filter cake was dried at 120° C. for 24 h and then roasted at 500° C. for 3 h, and the molecular sieve denoted as Z-E was prepared.

TABLE 1
Characterization results of the molecular sieves obtained in Examples and Comparative Examples

| | | | | | | The percentage |
|---|---|---|---|---|---|---|
| | | | | The di-tert- | The percentage | of the mesoporous |
| | | | The pyridine | butylpyridine | of the mesoporous | pore volume of |
| No. of | Outer surface | Total | infrared total | infrared total | pore volume | 2-10 nm to the |
| molecular | SiO₂/Al₂O₃ | SiO₂/Al₂O₃ | acid amount, | acid amount, | to the total | total mesoporous |
| sieve | molar ratio | molar ratio | mmol/g | *10⁻³ mmol/g | pore volum, % | pore volume, % |
| Z-T1 | 517 | 48.3 | 0.27 | 12.1 | 11.2 | 87 |
| Z-T2 | 560 | 45.4 | 0.29 | 12.0 | 11.5 | 85 |
| Z-T3 | 661 | 58.3 | 0.19 | 8.1 | 13.7 | 82 |
| Z-T4 | 989 | 54.7 | 0.20 | 5.3 | 13.3 | 82 |
| Z-T5 | 996 | 64.3 | 0.15 | 4.5 | 15.8 | 79 |
| Z-T6 | 680 | 62.8 | 0.17 | 13.2 | 15.9 | 77 |
| Z-T7 | 658 | 82.5 | 0.09 | 12.3 | 18.9 | 75 |
| Z-T8 | 715 | 81.6 | 0.12 | 11.6 | 19.1 | 72 |
| Z-B | 38.5 | 38.7 | 0.35 | 101 | 10.8 | 85 |
| Z-C | 94.5 | 94.3 | 0.06 | 46 | 10.9 | 86 |
| Z-D | 542 | 40.0 | 0.31 | 22.3 | 2.5 | 53 |
| Z-E | 952 | 56.7 | 0.18 | 5.8 | 1.3 | 21 |

### Example 9

The molecular sieve was prepared according to the same method in Example 5, except that the buffer solution in use was citric acid-ammonium citrate solution with a pH value of 5.0, the molecular sieve denoted as Z-T9 was prepared.

### Example 10

The molecular sieve was prepared according to the same method in Example 5, except that the pore canal protection solution was aqua ammonia with a concentration of 1.2 mol/L, the molecular sieve denoted as Z-T10 was prepared.

### Example 11

The molecular sieve was prepared according to the same method in Example 5, except that the organic acid in step (4) was 2-methylbenzenesulfonic acid, the molecular sieve denoted as Z-T11 was prepared.

### Example 12

The molecular sieve was prepared according to the same method in Example 5, except that the dealuminizing and silicon supplementing reagent was the fluosilicic acid solution with a concentration of 0.6 mol/L, the molecular sieve denoted as Z-T12 was prepared.

### Example 13

The catalysts were prepared by using the molecular sieves Z-T1 to Z-T12 obtained in Examples 1-12 respectively, wherein the preparation process was as follows: the calcined molecular sieves, macroporous alumina (with a specific surface area of 302 m²/g and a pore volume of 0.96 cm³/g), and an alumina sol binder were subjected to blending and kneading, extruding and molding, and subsequently subjected to drying and calcining to obtain the carriers; the carriers were impregnated in a nickel nitrate impregnation solution, and then subjected to drying and roasting to obtain the catalysts which were respectively denoted as C1-C12; wherein the mass fraction of the molecular sieve was 30 wt %, the mass fraction of the macroporous alumina was 50 wt %, the mass fraction of NiO was 10 wt %, and the balance was the binder.

10 g of catalysts C1-C12 were respectively taken and placed in a fixed bed reactor, and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 320° C., wherein the properties of the raw materials were shown in Table 2, and the product distribution and properties were illustrated in Table 3.

TABLE 2
The properties of oil products

| | Daqing oilfield mixed oil of straight- |
|---|---|
| Type of raw material | run diesel and catalytic diesel |
| Density (20° C.), kg/m³ | 864.0 |
| Distillation range, ° C. | 165-365 |
| Condensation point, ° C. | 18 |
| Wax content, wt % | 11.0 |
| Content of polycyclic aromatic | 15 |
| hydrocarbons, wt % | |
| Freezing point, ° C. | 5 |

TABLE 3
Application results of catalysts in Examples

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| C1 | 93.0 | 16.0 | 77.0 | −44 | 53.5 |
| C2 | 94.4 | 16.1 | 78.3 | −43 | 55.1 |
| C3 | 95.7 | 13.1 | 82.6 | −45 | 56.0 |
| C4 | 97.1 | 11.9 | 85.2 | −46 | 58.7 |
| C5 | 99.4 | 11.9 | 87.5 | −45 | 62.7 |
| C6 | 98.1 | 12.1 | 86.0 | −38 | 64.5 |
| C7 | 98.4 | 11.9 | 86.5 | −34 | 64.4 |
| C8 | 98.9 | 11.8 | 87.1 | −32 | 63.8 |
| C9 | 89.2 | 18.9 | 72.3 | −42 | 52.1 |
| C10 | 94.9 | 14.7 | 80.2 | −35 | 54.1 |
| C11 | 95.8 | 16.9 | 78.9 | −33 | 55.2 |
| C12 | 90.1 | 17.6 | 72.5 | −43 | 54.5 |

### Comparative Example 5

The commercially available ZSM-5 molecular sieve, macroporous alumina (with a specific surface area of 302 m²/g and a pore volume of 0.96 cm³/g), and an alumina sol binder were subjected to blending and kneading, extruding, and molding, and subsequently subjected to drying and calcining to obtain a carrier; the carrier was impregnated in a nickel nitrate impregnation solution, and then subjected to drying and roasting to obtain the catalyst denoted as DC1; wherein the mass fraction of the molecular sieve was 30 wt %, the mass fraction of the macroporous alumina was 50 wt %, the mass fraction of NiO was 10 wt %, and the balance was the binder.

10 g of the catalyst DC1 was weighed and placed in a fixed bed reactor and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 340° C., wherein the properties of the raw materials were shown in Table 2, and the product distribution and properties were illustrated in Table 4.

TABLE 4
Application results of the catalyst prepared by
using the commercially available molecular sieve

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| DC1 | 86.7 | 47.1 | 39.6 | −43 | 50.3 |

### Comparative Example 6

The molecular sieve Z-B, macroporous alumina (with a specific surface area of 302 m²/g and a pore volume of 0.96 cm³/g), and an alumina sol binder were subjected to blending and kneading, extruding and molding, and subsequently subjected to drying and calcining to obtain a carrier; the carrier was impregnated in a nickel nitrate impregnation solution, and then subjected to drying and roasting to obtain the catalyst denoted as DC2; wherein the mass fraction of the ZSM-5 molecular sieve was 30 wt %, the mass fraction of the macroporous alumina was 50 wt %, the mass fraction of NiO was 10 wt %, and the balance was the binder.

10 g of the catalyst DC2 was weighed and placed in a fixed bed reactor, and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 340° C., wherein the properties of the raw materials were shown in Table 2, and the product distribution and properties were illustrated in Table 5.

TABLE 5
Application results of the catalyst prepared
by using the Z-B molecular sieve

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| DC2 | 87.3 | 25.1 | 72.2 | −40 | 53.2 |

### Comparative Example 7

The molecular sieve Z-C, macroporous alumina (with a specific surface area of 302 m²/g and a pore volume of 0.96 cm³/g), and an alumina sol binder were subjected to blending and kneading, extruding and molding, and subsequently subjected to drying and calcining to obtain a carrier; the carrier was impregnated in a nickel nitrate impregnation solution, and then subjected to drying and roasting to obtain the catalyst denoted as DC3; wherein the mass fraction of the ZSM-5 molecular sieve was 30 wt %, the mass fraction of the macroporous alumina was 50 wt %, the mass fraction of NiO was 10 wt %, and the balance was the binder.

10 g of the catalyst DC3 was weighed and placed in a fixed bed reactor, and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 340° C., wherein the properties of the raw materials were shown in Table 2, and the product distribution and properties were illustrated in Table 6.

TABLE 6
Application results of the catalyst prepared
by using the Z-C molecular sieve

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| DC3 | 99.3 | 5.1 | 94.2 | −10 | 59.2 |

### Comparative Example 8

The molecular sieve Z-D, macroporous alumina (with a specific surface area of 302 m²/g and a pore volume of 0.96 cm³/g), and an alumina sol binder were subjected to blending and kneading, extruding and molding, and subsequently subjected to drying and calcining to obtain a carrier; the carrier was impregnated in a nickel nitrate impregnation solution, and then subjected to drying and roasting to obtain the catalyst denoted as DC4; wherein the mass fraction of the ZSM-5 molecular sieve was 30 wt %, the mass fraction of the macroporous alumina was 50 wt %, the mass fraction of NiO was 10 wt %, and the balance was the binder.

10 g of the catalyst DC4 was weighed and placed in a fixed bed reactor, and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 340° C., wherein the properties of the raw materials were shown in Table 2, and the product distribution and properties were illustrated in Table 7.

TABLE 7
Application results of the catalyst prepared
by using the Z-D molecular sieve

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| DC4 | 94.3 | 14.1 | 80.2 | −39 | 51.5 |

### Comparative Example 9

The molecular sieve Z-E, macroporous alumina (with a specific surface area of 302 m²/g and a pore volume of 0.96 cm³/g), and an alumina sol binder were subjected to blending and kneading, extruding and molding, and subsequently subjected to drying and calcining to obtain a carrier; the carrier was impregnated in a nickel nitrate impregnation solution, and then subjected to drying and roasting to obtain the catalyst denoted as DC5; wherein the mass fraction of the ZSM-5 molecular sieve was 30 wt %, the mass fraction of the macroporous alumina was 50 wt %, the mass fraction of NiO was 10 wt %, and the balance was the binder.

10 g of the catalyst DC5 was weighed and placed in a fixed bed reactor, and the hydrodewaxing reaction was performed under the conditions comprising the reaction pressure of 6.0 MPa, the hydrogen/oil volume ratio of 500:1, the liquid hourly volume space velocity of 10 h⁻¹, and the reaction temperature of 340° C., wherein the properties of the raw materials were shown in Table 2, and the product distribution and properties were illustrated in Table 8.

TABLE 8
Application results of the catalyst prepared
by using the Z-E molecular sieve

| | Total liquid | Naphtha | Diesel | Diesel | Cetane |
|---|---|---|---|---|---|
| No. of | yield, | yield, | yield, | condensation | number of |
| catalyst | wt % | wt % | wt % | point, ° C. | diesel |
| DC5 | 95.4 | 13.2 | 82.2 | −40 | 49.2 |

1-18. (canceled)

19. A ZSM-5 molecular sieve, wherein that the ZSM-5 molecular sieve has a pyridine infrared total acid amount within the range of 0.03-0.40 mmol/g, and a di-tert-butylpyridine infrared total acid amount within the range of 0.002-0.02 mmol/g; and the mesoporous pore volume of the ZSM-5 molecular sieve accounts for 10-20% of the total pore volume, and/or in the ZSM-S molecular sieve, the mesoporous pore volume of 2-10 nm accounts for 70-95% of the total mesoporous pore volume.

20. The molecular sieve of claim 19, wherein the ZSM-5 molecular sieve has a pyridine infrared total acid amount within the range of 0.10-0.20 mmol/g, and a di-tert-butylpyridine infrared total acid amount within the range of 0.005-0.01 mmol/g; and/or
the ratio of the outer surface SiO₂/Al₂O₃ molar ratio of said ZSM-5 molecular sieve to the total SiO₂/Al₂O₃ molar ratio of said ZSM-5 molecular sieve is within the range of (2-100):1.

21. The molecular sieve of claim 20, the ratio of the outer surface SiO₂/Al₂O₃ molar ratio of said ZSM-5 molecular sieve to the total SiO₂/Al₂O₃ molar ratio of said ZSM-5 molecular sieve is within the range of (5-30):1.

22. The molecular sieve of claim 19, wherein the outer surface SiO₂/Al₂O₃ molar ratio of said ZSM-5 molecular sieve is within the range of 200-1,000; and/or
the total SiO₂/Al₂O₃ molar ratio of said ZSM-5 molecular sieve is within the range of 30-100.

23. The molecular sieve of claim 22, wherein the outer surface SiO₂/Al₂O₃ molar ratio of said ZSM-5 molecular sieve is within the range of 500-1,000; and/or
the total SiO₂/Al₂O₃ molar ratio of said ZSM-5 molecular sieve is within the range of 40-70.

24. A preparation method of the ZSM-5 molecular sieve, wherein that the method comprises the following steps:
(1) subjecting a raw material ZSM-5 molecular sieve to a hydrothermal treatment;
(2) removing non-framework aluminum in the molecular sieve obtained in step (1);
(3) impregnating the material obtained in step (2) with a pore canal protection solution;
(4) treating the material obtained in step (3) with an organic acid;
(5) mixing the material obtained in step (4) with a dealuminizing and silicon supplementing reagent to dealuminize and supplement silicon;
(6) filtering, washing, drying, and roasting the material obtained in step (5).

25. The method of claim 24, wherein in step (1),
the temperature of the hydrothermal treatment is within the range of 400-700° C.;
and/or, the time of the hydrothermal treatment is within the range of 0.5-5 h; and/or
the pressure of the hydrothermal treatment is within the range of 0.05-0.5 MPa.

26. The method of claim 25, wherein in step (1),
the temperature of the hydrothermal treatment is within the range of 500-600° C.;
and/or, the time of the hydrothermal treatment is within the range of 1-2 h; and/or
the pressure of the hydrothermal treatment is within the range of 0.1-0.3 MPa.

27. The method of claim 24, wherein in step (2),
removing non-framework aluminum with a buffer solution, wherein the buffer solution is a mixed solution of the weak acid and/or weak base and corresponding salt thereof;
and/or, the weak acid is an inorganic acid and/or an organic acid that has a molecular size of less than 0.5 nm and can be removed in a mode of not damaging the structure of molecular sieve;
and/or, the inorganic acid is one or more of phosphoric acid, carbonic acid, and boric acid;
the inorganic acid salt is one or more of ammonium phosphate salt, ammonium carbonate salt, and ammonium borate salt;
the organic acid is selected from C2-C6 monobasic acid or polybasic acid, and/or one or more selected from the group consisting of citric acid, formic acid, acetic acid, oxalic acid, propionic acid, malonic acid, butyric acid, and succinic acid;
the organic acid salt is selected from C2-C6 monoacid or polybasic acid salts, and/or one or more selected from the group consisting of ammonium citrate, ammonium formate, ammonium acetate, ammonium oxalate, ammonium propionate, ammonium malonate, ammonium butyrate, and ammonium succinate;
and/or, the buffer solution is one or more of oxalic acid-ammonium oxalate solution and acetic acid-ammonium acetate solution.

28. The method of claim 27, wherein the pH of the buffer solution is within the range of 4.5-6.5; and/or
the molar concentration of acid in the buffer solution is within the range of 0.1-1.0 mol/L; and/or
the liquid-solid volume ratio of the buffer solution to the molecular sieve obtained in step (1) is within the range of 3:1-10:1.

29. The method of claim 24, wherein the process of step (2) comprises:
mixing and stirring the molecular sieve obtained in step (1) and a buffer solution, and then carrying out a solid-liquid separation; optionally repeating the above operations 2-4 times;
and/or, the treatment temperature is within the range of 40-80° C., and the treatment time is within the range of 0.5-3 h.

30. The method of claim 24, wherein in step (3),
the pore canal protecting agent of the pore canal protection solution is an inorganic alkali and/or an organic alkali that has a molecular size of less than 0.5 nm and can be removed through roasting in a mode of not damaging the structure of molecular sieve;
and/or, the pore canal protecting agent is one or more selected from the group consisting of aqua ammonia, ethylenediamine, propylamine, tetramethylammonium hydroxide,
tetraethylammonium hydroxide, tetrapropylammonium hydroxide, tetramethylammonium bromide, and tetraethylammonium bromide;
and/or, the pore canal protection solution is one or more selected from the group consisting of isopropylamine solution, tetraethylammonium hydroxide solution, and tetrapropylammonium hydroxide solution; and/or
the concentration of the pore canal protection solution is within the range of 0.8-2.0 mol/L.

31. The method of claim 24, wherein in step (3),
the impregnation is an equivalent-volume impregnation; and/or
the impregnation treatment temperature is within the range of 20-25° C.

32. The method of claim 24, wherein in step (4),
the organic acid is an organic acid that has a molecular size within the range from 0.55 nm to 2 nm and can be removed through roasting in a mode of not damaging the structure of molecular sieve;
and/or, the organic acid is one or more selected from the group consisting of C7-C10 organic acid;
and/or, the organic acid is one or more selected from the group consisting of 2-methylbenzoic acid, 2-methylbenzenesulfonic acid, 2,4-dimethylbenzenesulfonic acid, 2,4-dimethylbenzoic acid, 1,2,5-trimethylbenzenesulfonic acid, and 1,2,5-trimethylbenzoic acid;
and/or, the organic acid is one or more of 2,4-dimethylbenzenesulfonic acid and 2,4-dimethylbenzoic acid.

33. The method of claim 24, wherein the treatment process of step (4) comprises the following steps: mixing the material obtained in step (3) with water, and/or, the liquid-solid volume ratio of the water to the material obtained in step (3) is within the range of 2:1-6:1; and
then adding an organic acid until the pH value of said solution is reduced to below 8, and/or within the range of 6.5-7.5.

34. The method of claim 24, wherein in step (5),
the dealuminizing and silicon supplementing substance of the dealuminizing and silicon supplementing reagent is one or more selected from the group consisting of fluosilicic acid, fluosilicate, silicon halide and silicate ester, and/or one or more selected from the group consisting of ammonium hexafluorosilicate, fluosilicic acid, sodium fluosilicate, silicon tetrachloride, silicon tetrafluoride and ethyl orthosilicate;
and/or, the dealuminizing and silicon supplementing reagent is at least one of the ammonium hexafluorosilicate solution and tetraethoxysilane solution; and/or
the molar concentration of the dealuminizing and silicon supplementing reagent is within the range of 0.3-1.0 mol/L; and/or
the quality ratio of the material obtained in step (4) to the dealuminizing and silicon supplementing reagent is within the range of 1:1-1:5; and/or
the mixing temperature is within the range of 60-100° C.

35. The method of claim 24, wherein the operation procedure of step (5) comprises the following steps: heating the material obtained in step (4) to the temperature range of 60-100° C., continuously stirring, dropwise adding a dealuminizing and silicon supplementing reagent, and continuously stirring for 60-120 min after completion of the dropwise adding process.

36. A hydrodewaxing catalyst, wherein that the catalyst comprises the ZSM-5 molecular sieve of claim 19.

37. The hydrodewaxing catalyst of claim 36, the hydrodewaxing catalyst comprises the ZSM-5 molecular sieve and the Group VIII metal component, wherein the ZSM-5 molecular sieve is contained in an amount of 30-90%, and the group VIII metal component is contained in an amount of 5-40% calculated in terms of oxide, based on the weight of said catalyst.

38. The hydrodewaxing catalyst of claim 36, the hydrodewaxing catalyst comprises the ZSM-5 molecular sieve, alumina and Group VIII metal components, wherein the ZSM-5 molecular sieve is contained in an amount of 30-50%, the alumina is contained in an amount of 40-70%, and the Group VIII metal components are contained in an amount of 5-40% calculated in terms of oxide, based on the weight of said catalyst.
